(19) United States
(12) Patent Application Publication
(10) Pub. No.: US 2006/0145470 A1
(43) Pub. Date: Jul. 6, 2006

(54) Identification card forms

(76) Inventor: Thomas A. Holmberg, Andover, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/266,762

(22) Filed: Nov. 3, 2005

Related U.S. Application Data
(60) Provisional application No. 60/624,699, filed on Nov. 3, 2004.

(51) Int. Cl. B42D 15/00

(52) U.S. Cl. 283/98

(57) ABSTRACT

A sheetstock includes a sheet, a film layer laminated to the sheet, and an embossment in the sheet surface having a height about the same as a high of the film layer.

### CROSS-REFERENCE TO RELATED APPLICATION

This application claims the benefit under 35 U.S.C. 119 (e) of U.S. Provisional Application No. 60/624,699 filed on Nov. 3, 2004, which is hereby incorporated by reference in its entirety.

### FIELD

This application relates generally to business forms and more specifically to identification card forms.

### BACKGROUND

For many years identification cards have been produced on xerographic copiers and printers. These cards are typically made by laminating a reinforcing layer of plastic to one or both sides of a paper sheet and then perforating the card shape into the sheet. The base sheet stock is typically 8½″×11″ with one or more cards die cut into the sheet.

There have been several continuing problems with these products. One is that the film adds thickness to the sheet in only some areas. This causes a pile of the sheets to not stack evenly and so makes it very difficult to feed into the xerographic equipment. Additionally, rolls of material now can feed the newest xerographic equipment. The reason for this is to increase the efficiency of the machine. These rolls can be very large in diameter, up to 50″ and can contain 10,000 to 20,000 feet of material. If the material being wound is not level, the roll cannot be made nearly so large and so the efficiency of using a large roll is not achieved.

Another problem with current designs is the difficulty that some people have in seeing and removing the card from the base sheet stock. This is especially a concern for the elderly or anyone with poor eyesight.

A further problem relates to the clarity of the image that is copied into the card. It is desired that the images that are copied or printed onto the card surface be clear and easy to read. This information may contain account numbers, bar codes and member name etc. and must be legible and complete. If not, the card is useless and must be reprinted.

### BRIEF DESCRIPTION OF DRAWINGS

FIG. 1 shows a top view of a sheetstock in accordance with one embodiment.

FIG. 2 shows a side view of a pair of stacked sheetstock in accordance with one embodiment.

FIG. 3 shows a perspective view a portion of the sheetstock of FIG. 1.

FIG. 4 shows a top view of a sheetstock in accordance with one embodiment.

FIG. 5 shows a top view of a sheetstock in accordance with one embodiment.

FIG. 6 shows a top view of a sheetstock in accordance with one embodiment.

FIG. 7 shows a top view of a sheetstock in accordance with one embodiment.

FIG. 8 shows a side view of the sheetstock of FIG. 7.

FIG. 9 shows a top view of a sheetstock in accordance with one embodiment.

FIG. 10 shows a top view of a sheetstock in accordance with one embodiment.

FIG. 11 shows a side view of the sheetstock of FIG. 10.

FIG. 12 shows a top view of the sheetstock of FIG. 10, during production, in accordance with one embodiment.

FIG. 13 shows a side view of the sheetstock of FIG. 12 being laser cut, in accordance with one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

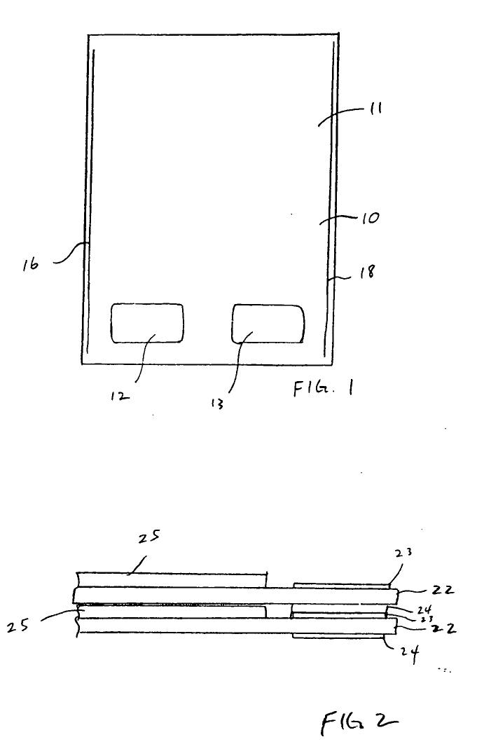

FIG. 1 shows a top view of a sheetstock 10 in accordance with one embodiment. Sheetstock 10 includes a base carrier sheet 11, for example a sheet of 8½×11 paper. Cards 12 and 13 are defined in the sheet. Cards 12 and 13 can include plastic material, 1 to 2 mils thick, for example. In one example, cards 12 and 13 are formed by laminating a layer of plastic to one or both sides of sheet 11 and then perforating the card shape into sheet 11 and the plastic layer. In another example, the plastic material can be pre-cut into the card shape and adhered onto sheet 11 to define cards 12 and 13. In a further example, to be discussed below, the plastic material is laser cut and the paper sheet is perforated by die-cutting.

Sheetstock 10 further includes one or more ridges or embossments 16, 18. Embossments 16, 18 help solve the problem of an uneven stack of sheetstock. In this example, embossments 16 and 18 run along the perimeter of the sheet, about ⅛″ to about ¼″ from the edge of the sheet. In other examples, embossments can run along three or four edges of the sheet. Embossments 16, 18 can be formed by dies, for example. These embossments can also be in the body of the sheet in areas that do not interfere with the printed copy. These embossments can have a variety of shapes but generally are dots or lines that are about 0.020″ to 0.040″ wide and can be up to 11″ long, or as long as the sheet, if over 11″. In various embodiments, the embossments 16, 18 project approximately 0.00075″ to 0.0015″ from the sheet surface. In one embodiment, the embossments can project approximately 0.00075″ to 0.040″ from the sheet surface.

In one example, the embossments 16, 18 are spaced on every other sheet so that as a pile of sheets is stacked the embossments do not nest into each other. For example, every other sheet 10 could have embossments about 1/16″ over from the previous and following sheets 10. The embossments 16, 18 serve the purpose of supporting, and spacing, the sheetstock 10 in the areas of the sheets that do not have the reinforcing plastic film of cards 12 and 13. The resulting stack of sheets lies flat and can be fed easily in standard xerographic equipment or other processing equipment.

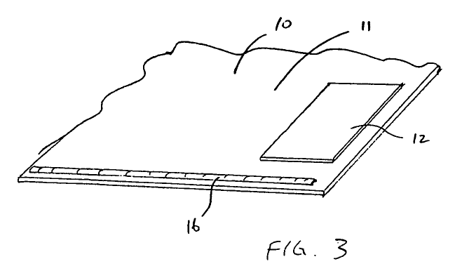

FIG. 3 shows a perspective view a portion of sheetstock 10. This view shows embossment 16 rising above the surface of sheet 11 to approximately the same height as the plastic film of card 12. In another example, if there is a plastic film on both sides of the sheet, then the embossment will be about twice as high as the thickness of a single plastic film.

FIG. 2 shows an example of a pair of stacked sheets 22, each having a plastic film 23, 24 on both sides of the sheet. In this example, an embossment 25 is about twice as high as each film 23, 24. For example, the embossment can be between 2 and 4 mils high. The pair of sheets 22 are shown stacked to show how the sheets to not stack unevenly since the embossment 25 takes up the height of both plastic films 23, 24.

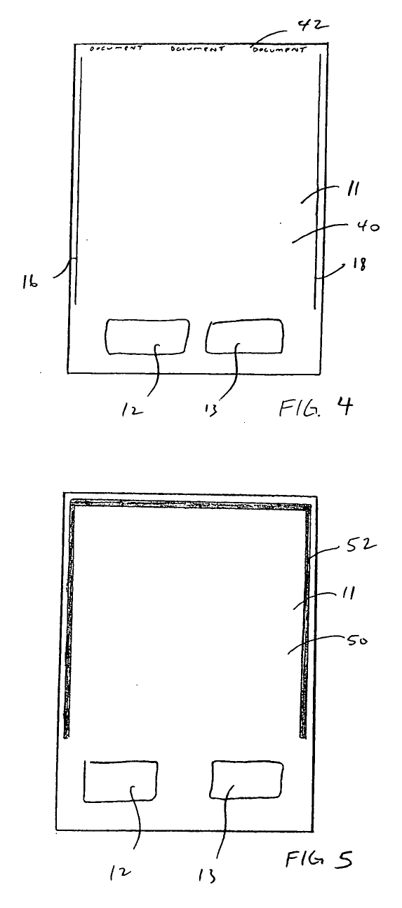

FIG. 4 shows a top view of a sheetstock 40 in accordance with one embodiment. Sheetstock 40 can include any features of sheetstock discussed above, such as embossments 16, 18 formed in sheet 11. In this example, a further embossment is provided by an embossment 42 which can form a name or symbol raised about 0.00075″ to about 0.040″ above the surface of the base sheet 11. This feature solves the same stacking problem but also provides a method to add a customer name, logo or even a security feature. This feature could be enhanced further by a combination of printing and embossing the name or logo.

FIG. 5 shows a top view of a sheetstock 50 in accordance with one embodiment. Sheetstock 50 can include any features of sheetstock discussed above. In this example, a raised area 52 is formed on base sheet 11 by a technique known as thermography. In this method, a powder is added to the sheet where one wants to raise the surface. The sheet with the powder attached is then heated. This causes the power to melt, expand, and fuse to the sheet stock. By adjusting the amount and type of powder, the embossing height of area 52 is achieved and controlled. Raised areas 52 can have dimensions of about 0.00075″ to about 0.040″ above a surface of the base sheet and can have a width of about 0.020″ to about 0.040″ or more.

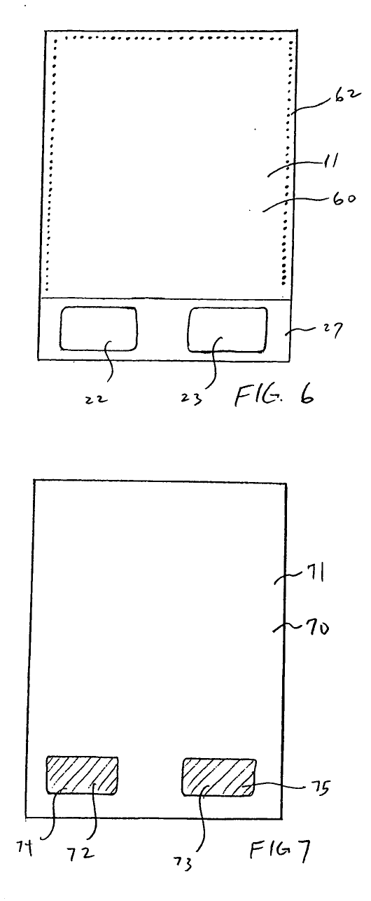

FIG. 6 shows a top view of a sheetstock 60 in accordance with one embodiment. Sheetstock 60 can include any features discussed above for other sheetstock. In this example, the embossment includes a plurality of raised bumps 62 extending around at least a portion of the perimeter of sheet 11. The bumps 62 can extend along the sides of the sheet or along the top and bottom of the sheet also, if so desired. In this example, cards 22 and 23 are formed by cutting the card shapes out of a layer of plastic film 27. Plastic film 27 has a thickness of about 1 to 2 mils, such as discussed above, and bumps 62 can have a height of about 0.00075″ to about 0.040″ above the surface of the base sheet 11.

Any of the examples discussed above can be combined in a single sheetstock. Moreover, any of these solutions will apply to product that is being produced for sheet fed or roll fed equipment.

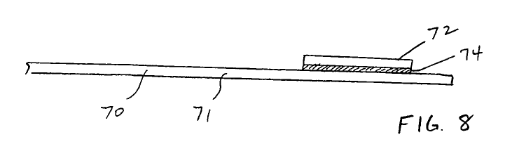

FIG. 7 shows a top view of a sheetstock 70 in accordance with one embodiment. FIG. 8 shows a side view of sheetstock 70. Sheetstock 70 generally includes a sheet 71 and one or more plastic films, 72 and 73, attached to the sheet with an adhesive 74, 75. Sheetstock 70 is designed to help solve the problem of being able to readily see the edges of the card which one needs to do for removal of a laminated or perforated card from the sheet.

In one embodiment, the problem is solved by two modifications that work together. First, in the past, a laminated sheet stock is produced by unwinding a roll of pressure sensitive adhesive tape and nipping this to a paper web. Alternately, a roll of plastic film is coated with an adhesive “inline” and then laminated to the paper web. In the present embodiment, a colorant has been added to adhesive 74, 75. This colorant can be any color desired. This colorant is mixed with the adhesive and remains under the final film layer 72, 73. In one example, No. 20CA2342 Hidacid Azure Blue Liquid 50% (made by Noveon Hilton Davis, Inc. of Cincinnati, Ohio) is mixed with adhesive No. PN 3759K (from H. B. Fuller Co. of St. Paul, Minn.).

The next step occurs in the die cutting/perforating process. In this step the excess film is removed as the card shape is perforated, leaving a clear or colored film only on the card portion of the sheet. The adhesive does not stay on the sheet (except under the plastic film 72, 73) because it is a slow acting adhesive and it is only pressed on over the card areas. The colored card edges of film layers 72, 73 are then clearly defined from the background sheet 71. This definition allows someone with poor eyesight to find the edge of the card and remove it easily. In this example, film layers 72, 73 are clear or sufficiently translucent so that the colored adhesive can be seen through the film layer.

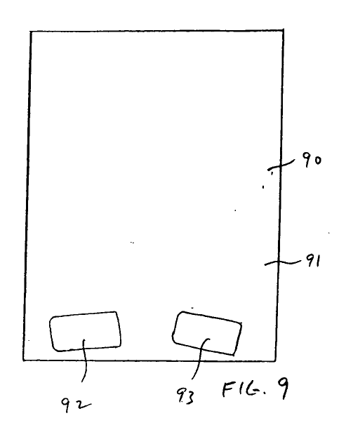

FIG. 9 shows a top view of a sheetstock 90 in accordance with one embodiment. Sheetstock 90 includes a base carrier sheet 91 and one or more cards 92, 93 which are perforated in sheet 91.

Sheet 90 is designed to help solve the problem of copy clarity for cards. The problem stems from the fact that the base sheet stock is made from paper that has a grain to it. This grain always goes in one direction (down web) and responds differently when folded or cut in the “with” grain direction versus the “across” grain direction. When cutting “with” the grain the paper fibers are easily spread apart with the knife or blade and very little fiber is actually cut. However, when cutting “across” the grain most all the fiber must be cut and not just spread apart. When cutting in this direction the cutting is much more difficult and requires much more force. This difficulty causes the paper to become distorted. This distortion can cause feeding, jamming and imaging issues in the xerographic process.

When sheets are xerographed an electrical charge holds the toner, in the shape of the image, in place on a thin film belt. This belt then transfers the toner to the substrate being imaged. The belt must come into intimate contact with the substrate for the transfer to occur. If the belt does not come in continuous contact with the substrate a void, or deletion, will occur in the final copy. The aforementioned distortion in the sheet stock that occurs during cross grain cutting can cause the belt to lose contact with the substrate and a deletion will occur.

The present example provides a solution to this problem by changing the direction of the die cutting or perforations. In the past, identification cards have been perforated with their edges at 0 degrees or 90 degrees relative to the sheet stock edge. In this example, by perforating cards 92 and 93 on a bias of at least about 15 degrees the cross grain vs. with grain distortion is eliminated. Each edge then needs the same amount of pressure to produce the perforations and the grain effect is eliminated. Once this distortion is eliminated the toner deletions are also eliminated and the final printed copy is complete and legible. In various examples, the cards can be biased (relative to the bottom horizontal edge of the paper) from about 15 degrees to about 75 degrees.

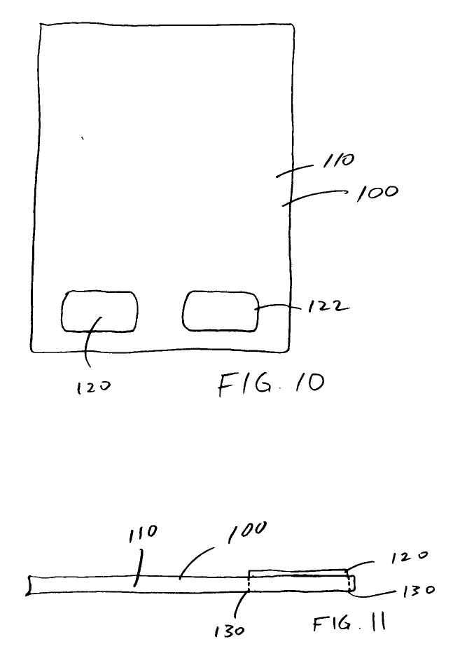

FIG. 10 shows a top view of a sheetstock 100, in accordance with one embodiment. FIG. 11 shows a side view of sheetstock 100. Sheetstock 100 includes a base sheet 110, such as a paper base sheet as discussed above. Film layers 120, 122 are positioned on the base sheet 110, and a perforation 130 is through the base sheet 110 around the perimeter of the card-shaped film layers 120, 122. In some embodiments, film layers can be laminated on both sides of the sheet, such as discussed above. Sheetstock 100 provides integrated cards (vs. tipped on or affixed cards). Integrated cards can provide cost savings and superior results in on demand equipment vs. affixed cards.

As discussed above, in the past, to form film layers such as film layers 120, 122 for an integrated card, a die cut was used through the plastic film. However, this leaves nicks or cuts on the edges because the die cutting process that cuts the cards, and perforates the paper and film, creates hundreds of these same nicks or cuts in the edges of the film on the perimeter of the card. Each of the nicks creates a weak point where the card can easily be torn or delaminated. If the card is removed successfully it is still subject to tearing during normal use because of the nicked edges. This negates much of the laminations value.

In contrast, sheetstock 100 is constructed by not cutting the film layer with a steel perforating die. Instead, referring to FIG. 13, a base film layer 105 is cut or melted by using a laser 140 to cut the film 105 via a laser beam 142. This laser 140, supplied by such companies as Coherent lasers of Santa Clara Calif., for example, is manipulated in such a way that it will cut the film layer 105 without cutting the paper base sheet 110 beneath it. The heat of the laser beam cuts, or melts, the film layer 105 and the resulting edges 175 of card-shaped film layers 120, 122 are smooth. These smooth edges 175 are very tear resistant and not like the nicked edges of previous cutting methods. In one example, the film shapes 120, 122 are cut with a galvanometer controlled laser beam.

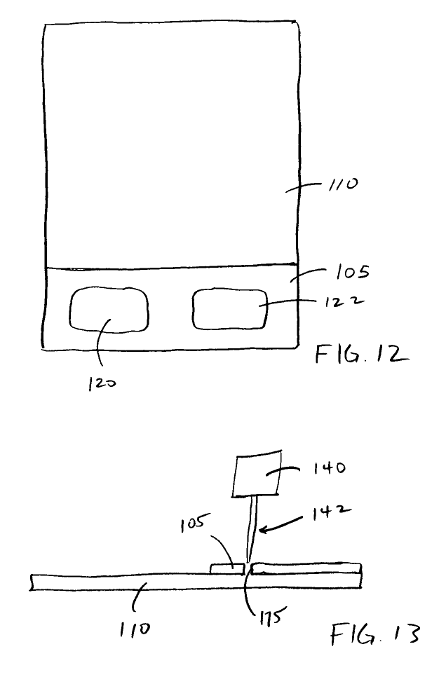

Referring to FIG. 12, after the laser cutting is done, all the extraneous base film 105 is removed from the sheet that is not laminated to the ID card itself (e.g. film layers 120, 122). This also results from the laser cutting a clean edge on the film with no small ties as found on conventional perforated forms. This allows the removal of the excess film from around the card leaving only film layers 120, 122 on the card itself. Without this clean laser cut completely around the card it is more difficult to remove the excess film.

In one example, in forming the sheetstock 110, the sheetstock can have film layers 105 laminated to both sides, where the film on one side has been laser cut in a shape of an ID card (or any other shape). Furthermore, the film on the other side is also laser cut in the same shape to a tolerance of + or −0.012″. After laser cutting, perforations 130 are formed in the same shape with the same tolerance that penetrate the paper base sheet 110 around the perimeters of film layers 120, 122.

The combination of these unique features creates an integrated card that solves significant problems with past integrated laminated ID card product. By removing the excess weight and thickness of the film, the card form will process better through the printing process without skewing or mis-registering. Moreover, because the film edges are not nicked or cut the integrated card will not tear or delaminate during removal from the form or during normal consumer use.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A sheetstock comprising:
a base sheet;
a film layer attached to the base sheet; and
an embossment in the sheet surface having a height at least about the same as a height of the film layer.

2. The sheetstock of claim 1, wherein the film layer includes a card-shaped layer.

3. The sheetstock of claim 2, wherein the card-shaped layer is affixed to a top surface of the base sheet.

4. The sheetstock of claim 2, wherein the card-shaped layer is laser cut.

5. The sheetstock of claim 1, wherein the embossment includes a ridge around at least a portion of a perimeter of the base sheet.

6. The sheetstock of claim 1, wherein the embossment includes raised letters or symbols.

7. The sheetstock of claim 1, wherein the embossment includes raised bumps.

8. The sheetstock of claim 1, wherein the embossment is raised about 0.00075″ to about 0.040″ above the surface of the base sheet.

9. A sheetstock comprising:
a sheet; and
a film layer adhered to the sheet and formed in the shape of a card, wherein the film layer is adhered to the sheet using a colored adhesive.

10. The sheetstock of claim 9, wherein the film layer is sufficiently translucent so that the colored adhesive can be seen through the film layer.

11. The sheetstock of claim 9, wherein the shape of the card is formed by laser cutting the shape of the card in the film layer.

12. The sheetstock of claim 9, including an embossment in the sheet surface having a height at least about the same as a height of the film layer.

13. The sheetstock of claim 12, wherein the embossment is raised about 0.00075″ to about 0.040″ above the surface of the base sheet.

14. A sheetstock comprising:
a base sheet; and
a film layer attached to the base sheet, where the film layer is laser cut into the shape of a card and wherein the base sheet is perforated in the shape of the card.

15. The sheetstock of claim 14, including a second film layer on a second side of the sheet, the second film layer also being laser cut.

16. A sheetstock comprising:
a base sheet; and
a card-shape perforated into the sheet and having an angle about 15 degrees or more relative to an edge of the sheet.

17. The sheetstock of claim 16, wherein the card-shape includes a film layer laminated over the card-shape.
